(19) United States
(12) Patent Application Publication
(10) Pub. No.: US 2006/0066860 A1
(43) Pub. Date: Mar. 30, 2006

(54) Sensor utilizing attenuated total internal reflection

(75) Inventor: Shu Sato, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/239,304

(22) Filed: Sep. 30, 2005

(30) Foreign Application Priority Data
Sep. 30, 2004 (JP) 288104/2004

(51) Int. Cl. G01N 21/55

(52) U.S. Cl. 356/445

(57) ABSTRACT

A measuring unit includes: a dielectric block, transparent with respect to a light beam; and a thin film layer, formed on a surface of the dielectric block. A light beam is caused to enter the dielectric block at various incident angles, such that total reflection conditions are obtained at an interface between the dielectric block and the thin film layer. The light beam totally reflected at the interface is detected by a two dimensional imaging means, constituted by photoelectric converting elements, arranged in the vertical and horizontal directions. The state of attenuated total reflection is measured, based on output from the imaging means. The photoelectric converting elements of the imaging means are arranged such that a first arrangement direction is parallel to a plane including the incident light and reflected light. The imaging means only outputs the sums of charges of the photoelectric converting elements arranged in a second direction.

### BACKGROUND OF THE INVENTION

1. Field of the Invention

The present invention relates to a sensor that utilizes attenuated total internal reflection, such as a surface plasmon sensor that utilizes the generation of surface plasmon to analyze the properties of a substance. Particularly, the present invention relates to a sensor that utilizes attenuated total internal reflection, in which a two dimensional imaging means constituted by a plurality of photoelectric converting elements arranged in rows and columns is employed.

2. Description of the Related Art

Surface plasmon sensors are known, as a sensor that utilizes evanescent waves. In metals, free electrons oscillate in groups to generate compression waves, called plasma waves. The compression waves which are generated at the surface of metals are called surface plasmon, when quantized. Various known surface plasmon sensors utilize a phenomenon, in which the surface plasmons are excited by light waves, to analyze properties of samples. Particularly well known surface plasmon sensors are those of a Kretschmann configuration (as disclosed in Japanese Unexamined Patent Publication No. 6(1994)-167443, for example).

Surface plasmon sensors of the Kretschmann configuration basically comprise: a dielectric block, shaped as a prism, for example; a metal film, formed on one surface of the dielectric block and which is brought into contact with a sample; a light source for emitting a light beam; an optical system for causing the light beam to enter the dielectric block at various angles of incidence so that total internal reflection conditions are satisfied at an interface of the dielectric block and the metal film; a photodetecting means for detecting the intensity of the light beam, which has been totally reflected at the interface; and a measuring means for measuring the state of surface plasmon resonance, based on detection results obtained by the photodetecting means.

In order to obtain various angles of incidence for the light beam, a comparatively thin incident light beam may be caused to impinge upon the interface while changing the angle of incidence. Alternatively, a comparatively thick incident light beam may be caused to impinge upon the interface in the form of convergent light or divergent light, so that the incident light beam includes components impinging upon the interface at various angles. In the former case, the light beam which is reflected from the interface at an angle, which varies as the angle of incidence changes, may be detected by a small photodetector which is moved in synchronization with the change of the angle of incidence, or by an area sensor that extends in the direction coincident with the angles of reflected light. In the latter case, an area sensor, which extends in directions such that all the components of light reflected from the interface at various angles can be detected thereby, may be employed.

In a surface plasmon sensor of the construction described above, when a light beam impinges upon the metal film at a particular angle of incidence θₛₚ greater than or equal to the angle of total internal reflection, evanescent waves having an electric field distribution in a sample which is in contact with the metal film are generated, and surface plasmon is excited at an interface between the metal film and the sample. When the wave vector of the evanescent light is equal to the wave number of the surface plasmon and wave number matching is established, the evanescent waves and the surface plasmon resonate and light energy is transferred to the surface plasmon, whereby the intensity of light reflected in total internal reflection at the interface of the dielectric block and the metal film sharply drops. The sharp intensity drop is generally detected as a dark line by the photodetector.

The aforesaid resonance occurs only when the incident light beam is p-polarized. Accordingly, it is necessary to set the surface plasmon sensor so that the light beam enters the interface as p-polarized light.

When the wave number of the surface plasmon can be known from the angle of incidence θₛₚ at which the phenomenon of attenuation in total internal reflection (ATR) takes place, the dielectric constant of the sample can be obtained. That is,

$${K}_{sp} ( ω ) = \frac{ω}{c} \sqrt{\frac{{ɛ}_{m} ( ω ) {ɛ}_{s}}{{ɛ}_{m} ( ω ) + {ɛ}_{s}}}$$

wherein Kₛₚ represents the wave number of the surface plasmon, ω represents the angular frequency of the surface plasmon, c represents the speed of light in a vacuum, and εm and εs respectively represent the dielectric constants of the metal and the sample.

When the dielectric constant εs of the sample is known, the refractive index and the like of the sample can be determined on the basis of a predetermined calibration curve or the like. As a result, properties of the sample related to the refractive index, such as the dielectric constant, can be determined, by determining the angle θₛₚ at which attenuated total reflection occurs (hereinafter, referred to as “attenuated total reflection angle θₛₚ”) As a similar type of sensor that utilizes evanescent waves, there is known a leaky mode sensor as described in, for instance, “Surface Refracto-sensor using Evanescent Waves: Principles and Instrumentations” by Takayuki Okamoto, Spectrum Researches, Vol. 47, No. 1 (1998), pp. 21-23 and pp. 26-27. The leaky mode sensor basically comprises: a dielectric block, shaped as a prism, for example; a cladding layer, formed on one surface of the dielectric block; an optical waveguide layer, which is formed on the cladding layer and which is brought into contact with a sample; a light source for emitting a light beam; an optical system for causing the light beam to enter the dielectric block at various angles of incidence so that total internal reflection conditions are satisfied at an interface of the dielectric block and the cladding layer; a photodetecting means for detecting the intensity of the light beam, which has been totally reflected at the interface; and a measuring means for measuring the state of excitation of a waveguide mode, based on detection results obtained by the photodetecting means

In a leaky mode sensor of the construction described above, when the light beam is caused to impinge upon the cladding layer through the dielectric block at an angle greater than or equal to an angle of total internal reflection, evanescent waves are generated in the optical waveguide layer and an evanescent wave having a particular wave number comes to propagate through the optical waveguide layer in a waveguide mode. When the waveguide mode is thus excited, almost all the incident light which generates the evanescent wave having a particular wave number is taken into the optical waveguide layer and accordingly, the intensity of light reflected in total internal reflection at the interface of the dielectric block and the clad layer sharply drops. Because the wave number of light to be propagated through the optical waveguide layer depends upon the refractive index of the sample on the optical waveguide layer, the refractive index and properties of the sample related to the refractive index can be determined, based on the attenuated total reflection angle θₛₚ.

The aforementioned surface plasmon sensors and leaky mode sensors may be utilized to perform random screening in the field of pharmaceutical manufacture. In random screening, specific substances that bond with a desired sensing substance are sought. In this case, the sensing substance is disposed on the thin film (the metal film in the case of a surface plasmon sensor, and the optical waveguide layer and the cladding layer in the case of a leaky mode sensor). Then, various solutions of test targets (sample liquids) are added to the sensing substance. Each time that a predetermined amount of time passes, the attenuated total internal reflection angle θₛₚ is measured. If the test target binds with the sensing substance, the refractive index of the sensing substance changes over time due to the bond. Accordingly, whether the test target is bonding with the sensing substance, that is, whether the test target is the specific substance that bonds with the sensing substance, can be determined by measuring the attenuated total internal reflection angle θₛₚ at predetermined time intervals, thereby measuring whether the attenuated total reflection angle θₛₚ changes. A combination of an antigen and an antibody is an example of the combination of the specific substance and the sensing substance. Alternatively, a combination of an antibody and another antibody may be the combination of the specific substance and the sensing substance. Measurement regarding whether a rabbit antihuman IgG antibody, as a sensing substance, bonds with an antihuman IgG antibody, as a specific substance, and quantitative analysis of the bond, are specific examples of measurement.

Note that it is not necessary to detect the attenuated total reflection angle θₛₚ itself, in order to measure bonding states between test targets and sensing substances. For example, a sample liquid may be added to a sensing substance, then the variation in the attenuated total reflection angle θₛₚ may be measured. The bonding state may be measured, based on the degree of the variation of the attenuated total reflection angle θₛₚ.

In conventional sensors that utilize attenuated total reflection, area sensors that extend in directions that are capable of receiving light reflected at various angles of reflection are employed. It is often the case that two dimensional imaging means, in which a plurality of photoelectric converting elements are arranged in rows and columns and which are increasing in imaging resolution, are employed as these area sensors. A two dimensional CCD imaging element is an example of such a two dimensional imaging means. However, in cases that these two dimensional imaging means are employed, the readout time required to read out signals from the two dimensional imaging means is long. Therefore, there is a problem that it is difficult to shorten the intervals between measurements of the state of attenuated total reflection.

### SUMMARY OF THE INVENTION

The present invention has been developed in view of the above circumstances. It is an object of the present invention to provide a sensor that utilizes attenuated total reflection, which is capable of shortening intervals between measurements of the state of attenuated total reflection.

The sensor that utilizes attenuated total reflection according to the present invention comprises:

a light source, for emitting a light beam;

a measuring unit, constituted by: a dielectric block which is transparent with respect to the light beam; a thin film layer, which is formed on a surface of the dielectric block; and a sample holding mechanism, for holding a sample on the thin film layer;

an optical system, for causing the light beam to enter the dielectric block at various angles of incidence, such that total internal reflection conditions can be obtained at an interface between the dielectric block and the thin film layer;

two dimensional imaging means, constituted by a plurality of photoelectric converting elements which are arranged in the vertical and horizontal directions, for detecting the intensity of the light beam, which is totally reflected at the interface; and

measuring means, for measuring the state of attenuated total internal reflection, based on the output from the two dimensional imaging means;

the photoelectric converting elements of the two dimensional imaging means being arranged such that a first direction in which they are arranged, from between the vertical and horizontal directions, is parallel to a plane that includes the light incident on the interface and reflected light; and

the two dimensional imaging means only outputting the sums of charges of the photoelectric converting elements which are arranged in a second direction, from between the vertical and horizontal directions, not parallel to the plane that includes the incident light and the reflected light.

Note that the two dimensional imaging means is arranged such that the reflected light is incident on an imaging surface thereof. Here, “only outputting the sums of charges of the photoelectric converting elements which are arranged in a second direction, from between the vertical and horizontal directions, not parallel to the plane that includes the incident light and the reflected light” means that charges of the photoelectric converting elements, which are arranged in the first direction, are not added as a basic rule. However, there are cases in which a great number of photoelectric converting elements are arranged in the first direction, and sufficient image resolution in the first direction can be obtained by adding the charges thereof. In these cases, addition of the charges of the photoelectric converting elements, which are arranged in the first direction, may be performed.

The two dimensional imaging means may be an imaging means of the charge transfer type.

In the sensor that utilizes attenuated total reflection according to the present invention, the intensity of the light beam, which is totally internally reflected at the interface, is detected by the two dimensional imaging means, in which the photoelectric converting elements are arranged such that the first direction in which they are arranged, from between the vertical and horizontal directions, is parallel to a plane that includes the light incident on the interface and reflected light. The two dimensional imaging means outputs only the sum of the charges of the photoelectric converting elements, which are arranged in the second direction. Thereby, the time required to read out signals from the two dimensional imaging means can be reduced. Accordingly, the intervals between measurements of the state of attenuated total reflection can be shortened.

A configuration may be adopted, wherein the two dimensional imaging means is an imaging means of the charge transfer type. In this case, when performing vertical or horizontal transfer, noise during readout of signal charges can be reduced, due to outputting only the sum of charges of the photoelectric converting elements, which are arranged in the second direction. Accordingly, the S/N ratio of the read out signals is improved.

### BRIEF DESCRIPTION OF THE DRAWINGS

FIG. 1 is a diagram that illustrates the entire construction of a surface plasmon sensor according to a first embodiment of the present invention.

FIG. 2 is a diagram that illustrates the detailed construction of a link unit, which is employed in the surface plasmon sensor.

FIG. 3 is a partial sectional side view of the main parts of the surface plasmon sensor.

FIG. 4 is a schematic diagram of a flow path unit, which is employed in the surface plasmon sensor.

FIG. 5 is a schematic diagram of a two dimensional CCD imaging element, which is employed in the surface plasmon sensor.

FIG. 6 is a block diagram that illustrates a measuring means, which is employed in the surface plasmon sensor.

FIGS. 7A and 7B are diagrams for explaining the relationship between light intensity for each incident angle of a light beam, and the outputs of the two dimensional CCD imaging element.

FIG. 8 is a graph that illustrates an example of a sensorgram output by the surface plasmon sensor.

FIG. 9 is a partial sectional side view of the main parts of a leaky mode sensor according to a second embodiment of the present invention.

### DESCRIPTION OF THE PREFERRED EMBODIMENTS

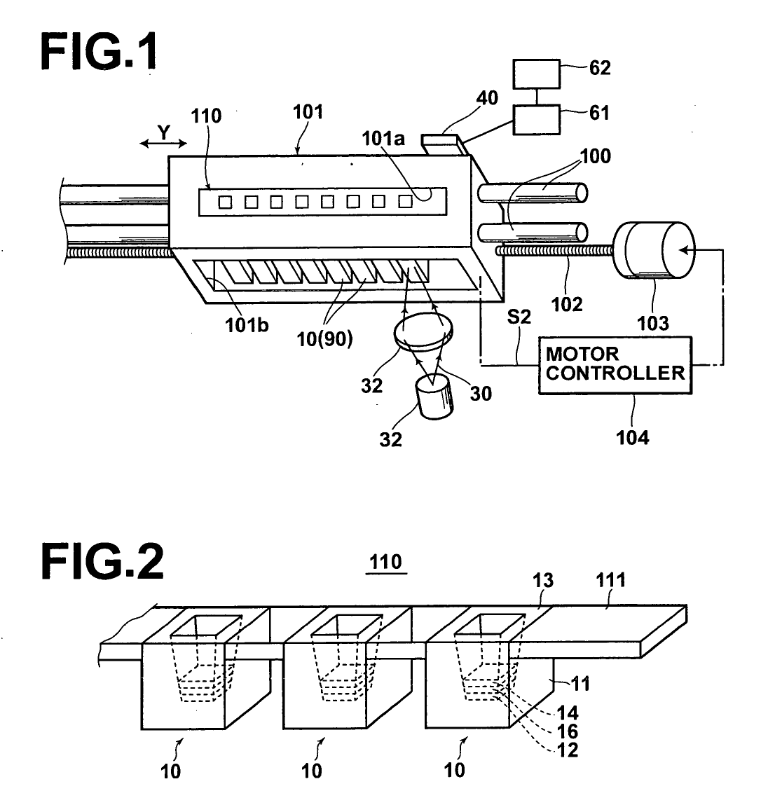

Hereinafter, embodiments of the present invention will be described in detail with reference to the attached drawings. FIG. 1 is a diagram that illustrates the entire construction of a surface plasmon sensor, which is a sensor that utilizes attenuated total reflection according to a first embodiment of the present invention.

The surface plasmon sensor measures states of bonding between sensing substances and test targets. The surface plasmon sensor measures variations in attenuated total reflection angles θₛₚ due to surface plasmon resonance, and generates sensorgrams that represent the variation of the angles over time.

As illustrated in FIG. 1, the surface plasmon sensor of the first embodiment employs a sliding block 101 as a support for measuring units. The sliding block 101 is slidably engaged with two guide rods 100, 100, which are provided parallel to each other. Thereby, the sliding block 101 is linearly slidable in the direction of arrow Y. The sliding block is in threaded engagement with a precision threaded rod 102, which is provided parallel to the guide rods 100, 100. The precision threaded rod 102 is configured to be rotated in the forward and reverse directions by a pulse motor 103. The pulse motor 103 and the precision threaded rod 102 constitute a support drive means.

Note that driving of the pulse motor 103 is controlled by a motor controller 104. That is, an output signal S2 of a linear encoder (not shown), which is built into the sliding block 101 and which detects the position of the sliding block 101 along the longitudinal direction of the guide rods 100, 100, is input to the motor controller 104, and the motor controller 104 controls the driving of the pulse motor 103 based on the signal S2.

A laser light source 31 that emits a measuring light beam 30 (laser beam) and a condensing lens 32 that constitutes an incident optical system are provided below and to the side of the guide rods 100, 100. A two dimensional CCD imaging element 40, which is constituted by a plurality of photoelectric converting elements provided in the vertical and horizontal directions, is provided at the side of the sliding block 101 opposite from that of the laser light source 31 and the condensing lens 32. That is, the sliding block 101 is sandwiched between the laser light source 31 and the condensing lens 32; and the two dimensional CCD imaging element 40. A measuring means 61 that receives output signals S from the two dimensional CCD imaging element 40 is connected thereto. The measuring means 61 performs processes based on the signals S, as will be described later. A display section 62 is connected to the measuring means 61. Note that the display section 62 functions as a final output means of the present invention.

In the present embodiment, a stick type link unit 110, in which eight measuring units 10 are linked and fixed, is employed. The measuring units 10 are set in the sliding block 101 in a state in which eight of them are arranged in a row.

FIG. 2 is a diagram that illustrates the details of the construction of the link unit 110. As illustrated in FIG. 2, the measuring units 10 are linked by linking portions 111, to form the link unit 110.

As illustrated in FIG. 2, each measuring unit 10 comprises: a dielectric block 11, which is formed substantially as a cube; and a metal film 12, which is formed on a surface (the upper surface in FIG. 2) of the dielectric block 11. The metal film 12 is formed of gold, silver, copper, or aluminum, for example.

The dielectric block 11 is formed by transparent resin, for example, and the periphery of the portion, at which the metal film 12 is formed, is raised as banks. The cavity 13 formed by the raised banks functions as a sample holding mechanism, for holding samples therein. Note that in the present embodiment, a dextran layer 16 is coated on the metal film 12, and a sensing substance 14 is fixed on the dextran layer 16. The measuring unit may be utilized with a flow path unit 70, which is illustrated in FIG. 4. The flow path unit 70 will be described later.

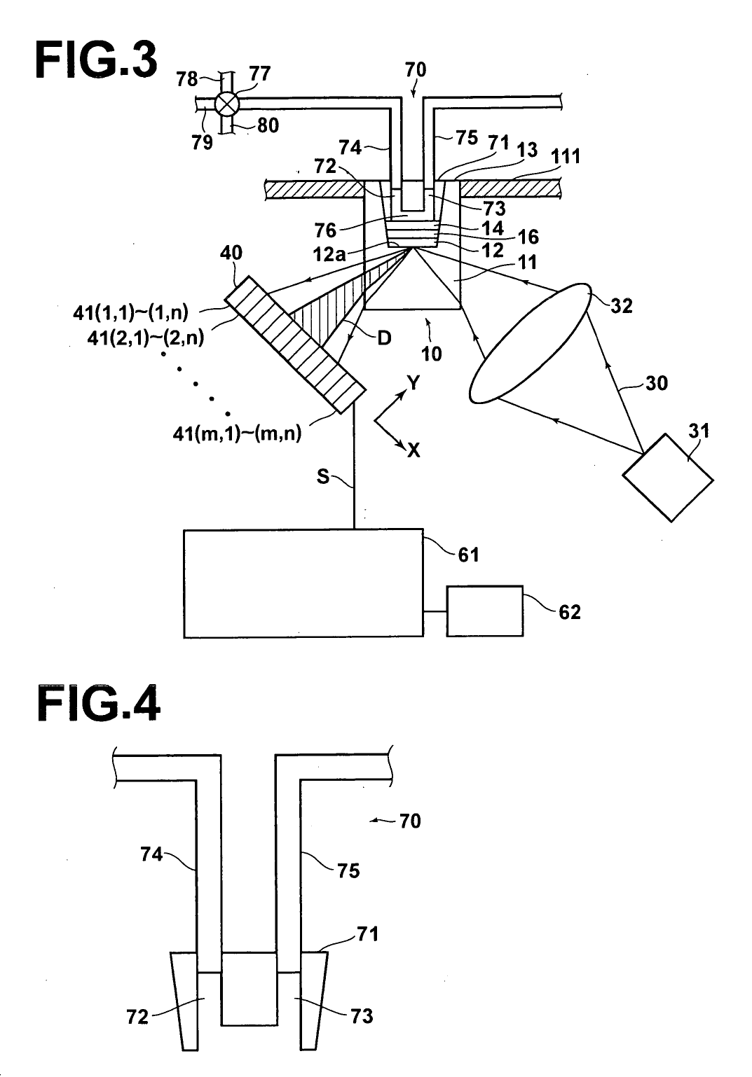

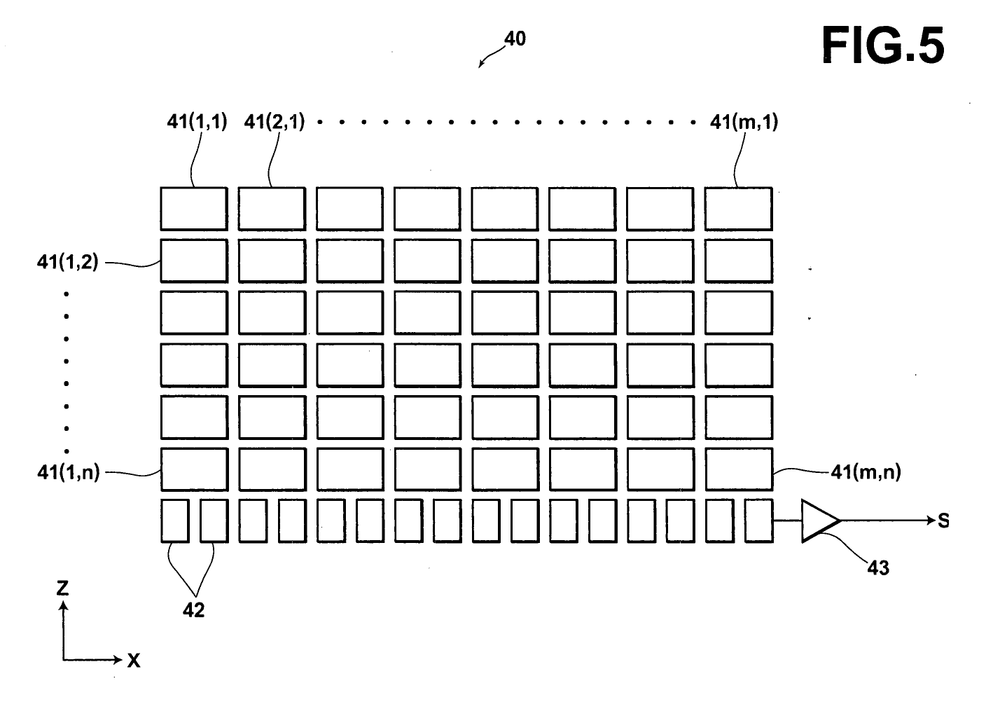

The condensing lens condenses the light beam 30 such that it enters the dielectric block 11 in a convergent state, as illustrated in FIG. 3. Thereby, various angles of incidence can be achieved with respect to an interface 12a between the dielectric block 11 and the metal film 12. The range of the angles of incidence is that which includes angular ranges that enable obtainment of total internal reflection conditions at the interface 12a and that enable surface plasmon resonance.

Note that the light beam 30 enters the interface 12a in a p-polarized state. In order to cause the light beam 30 to enter the interface 12a in a p-polarized state, the laser light source 31 may be provided such that the polarization direction thereof is in the direction of p-polarization. Alternatively, a wavelength plate or a polarizing plate may be employed to control the polarization direction of the light beam 30.

The two dimensional CCD imaging element 40 is a CCD imaging element of the full frame type, in which vertical transfer CCD's 41(1, 1) through 41(m, n) are arranged in m vertical columns and n horizontal rows. The vertical transfer CCD's 41(1, 1) through 41(m, n) are transparent electrodes formed by polysilicon, for example, and perform photoelectric conversion themselves. Signal charges are accumulated in the vertical transfer CCD's 41 (1, 1) through 41(m, n) by the photoelectric conversion. The signal charges are vertically transferred, then horizontally transferred by horizontal transfer CCD's 42 through an output circuit 43, to be output to the measuring means 61. Note that the vertical transfer CCD's 41(1, 1) through 41(m, n) are provided such that their lateral directions are parallel to a plane that includes the light beam 30 incident onto the interface 12a and reflected light thereof. More specifically, the two dimensional CCD imaging element 40 is provided such that the lateral directions of the vertical transfer CCD's 41(1, 1) through 41(m, n) correspond to direction X in FIG. 3. The direction X in FIG. 3 is perpendicular to direction Y, which is the direction of the optical axis of the reflected light. Accordingly, the vertical directions of the vertical transfer CCD's 41(1, 1) through 41(m, n) correspond to a direction Z, which is perpendicular to a plane defined by directions X and Y. The signal charges accumulated in each column of the vertical transfer CCD's 41(1, 1) through 41(m, n) are added by a binning process, and transferred to the horizontal transfer CCD 42 corresponding to the column. Then, the added signal charges are sequentially horizontally transferred by the horizontal transfer CCD's 42 through the output circuit 43, to be output to the measuring means 61. Note that the lateral directions of the vertical transfer CCD's 41 are not limited to corresponding to the direction X. The two dimensional CCD imaging element 40 may be provided such that the lateral directions of the vertical transfer CCD's 41 correspond to any direction which is parallel to the plane that includes the light beam 30 incident onto the interface 12a and reflected light thereof, as long as the light beam 30 is incident within the region of the vertical transfer CCD's 41.

Note that when assembling the sensor, it is necessary to precisely place the two dimensional CCD imaging element, such that the lateral direction thereof is parallel to the plane that includes the light beam 30 incident onto the interface 12a and reflected light thereof. For example, first, a light beam may be irradiated onto a measuring unit that generates attenuated total reflection. Then, the two dimensional CCD imaging element 40 may be placed such that it is perpendicular with respect to the optical axis of reflected light, and such that the optical axis enters the center thereof. Next, the two dimensional CCD imaging element 40 maybe rotated about the optical axis of the light beam, such that a dark line extends in the vertical direction of the vertical transfer CCD's 41. In this case, if the two dimensional CCD imaging element 40 is rotated based on an image imaged thereby, more accurate placement can be achieved.

Note that pipettes and the like may be employed to supply sample liquids to the measuring units 10. Alternatively, the flow path unit 70 of FIG. 4 may be attached to the measuring units 10, and the sample liquids may be supplied via flow paths.

The flow path unit 70 comprises: a flow path holder 71, which is formed substantially as a quadrangular pyramid having a portion cut off therefrom; a supply path 72, for supplying sample liquids; and a discharge path 73, for discharging sample liquids. The supply path 72 and the discharge path 73 are formed within the flow path holder 71. The flowpath unit 70 can be easily mounted in and removed from the interior of the measuring units 10. Teflon™ tubes 74 and 75 are respectively attached to the supply path 72 and the discharge path 73. When the flow path unit 70 is mounted in the measuring unit 10, a measurement flow path 76, which is sealed by the metal film 12 and the flow path unit 70, is formed, as illustrated in FIG. 3.

A switchable pump 77 is connected to Teflon™ tube, which is connected to the supply path 72 of the flow path unit 70. A sample liquid supply path 78, a buffer liquid supply path 79, and an air supply path 80 are connected to the switchable pump 77. A liquid supply section (not shown), at which sample liquids are prepared, is connected to the sample liquid supply path 78. A liquid supply section (not shown), at which buffer liquid is prepared, is connected to the buffer liquid supply path 79. An air supply section (not shown) is connected to the air supply path 80. Note that the supply sections connected to each of the supply paths are interchangeable, and are switched as necessary.

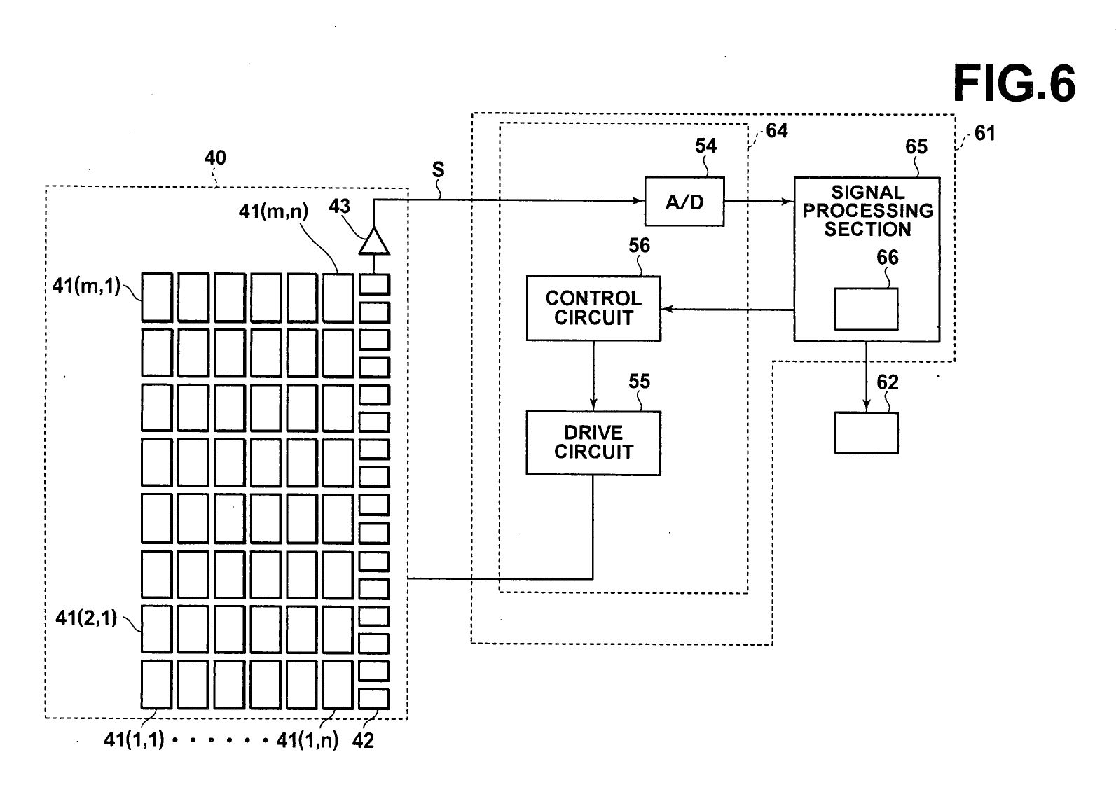

The measuring means 61 comprises: a driver 64, which is connected to the two dimensional CCD imaging element 40; and a signal processing section 65, constituted by a computer system or the like, as illustrated in FIG. 6.

As illustrated in FIG. 6, the driver 64 comprises: an A/D converter 54, for digitizing the output from the two dimensional CCD imaging element 40 and inputting the digitized output to the signal processing section 65; a drive circuit 55, for driving the two dimensional CCD imaging element 40; and a control circuit 56, for controlling the operation of the drive circuit 55, based on commands from the signal processing section 65.

The signal processing section 65 calculates a variation R that reflects temporal changes in attenuated total reflection angles θₛₚ, that is, temporal changes of a bonding state or a dissociating state of a sensing substance and a test target within a sample liquid, at 0.5 second intervals. The variation R is recorded in a memory section 66, and output to the display section 62. The display section 62 displays a sensorgram that represents changes in the variation R over time. Note that after measurements are completed, the signal processing section 65 derives a bond curve and a dissociation curve, which are speed equations, that fit the sensorgram, based on the sensorgram. Thereafter, a bonding speed constant, derived from the sensorgram, the bond curve, and the dissociation curve; and a dissociating speed constant, derived from the dissociation curve; are output to the display section 62. The display section 62 displays the bonding speed constant and the dissociating speed constant.

Hereinafter, the operations, by which the surface plasmon sensor constructed as described above measures angular variations of attenuated total reflection angles θₛₚ, due to surface plasmon resonance, will be described. First, the sliding block 101 is moved so that a desired measuring unit 10 is placed in a measurement position. That is, the sliding block 101 is moved such that the desired measuring unit 10 is sandwiched between the laser light source 31 and the condensing lens 32, which constitutes the incident optical system, and the two dimensional CCD imaging element 40. The sample liquid supply path 78 is connected to the tube 74 by the switchable pump 77, and sample liquid is supplied into the measurement flow path 76 of the measuring unit 10. Note that supply of the sample liquid is ceased when the measurement flow path 76 is filled with the sample liquid. Measurements to follow thereafter are performed in a state in which the measurement flowpath 76 is filled with the sample liquid.

Measurement time t is measured by a timer (not shown), with the point in time at which the sample liquid is supplied to the measuring unit 10 as a reference.

The laser light source 31 is driven in this state, and the light beam 30 emitted thereby enters the interface 12a between the dielectric block 11 and the metal film 12 in a convergent state. The light beam 30, which is totally internally reflected at the interface 12a, is detected by the two dimensional CCD imaging element 40.

As described previously, the lateral directions of the vertical transfer CCD's 41(1, 1) through (m, n) of the two dimensional CCD imaging element 40 correspond to direction X of FIG. 3. Accordingly, each component of the light beam 30, which is reflected at various reflective angles at the interface 12a, is received by a different row of the vertical transfer CCD's 41. That is, a component which is reflected at a certain angle is received vertical transfer CCD's 41(i, 1) through 41(i, n) of an i^{th} row, and a component which is reflected at a slightly different angle is received by vertical transfer CCD's 41(i+1, 1) through 41(i+1, n) of an i+1^{th} row. The components of the light beam 30, reflected at all of the reflective angles, are sequentially received by the rows of vertical transfer CCD's 41. When emission of the light beam 30 is completed, signal charges, which are accumulated in each vertical column of the vertical transfer CCD's 41 are added by a binning process, and transferred to the horizontal transfer CCD 42 corresponding to the column. Then, the added signal charges are sequentially horizontally transferred by the horizontal transfer CCD's 42 through the output circuit 43, to be output to the measuring means 61. Note that by reading out the signal charges after performing the binning processes in this manner, the readout time is reduced to 1/10^{th} or less of the readout time required in the case that the signal charges are individually read out from each of the vertical transfer CCD's 41. In addition, noise being added to signals by output circuits is generally unavoidable, when reading out signal charges. However, because the signal charges are added to become comparatively large charges by the binning processes prior to being output, the S/N ratio of signals output from the output circuit 43 is improved.

The outputs from each of the columns of vertical transfer CCD's are input to the A/D converter according to a predetermined order. The A/D converter digitizes the outputs and inputs them to the signal processing section 65.

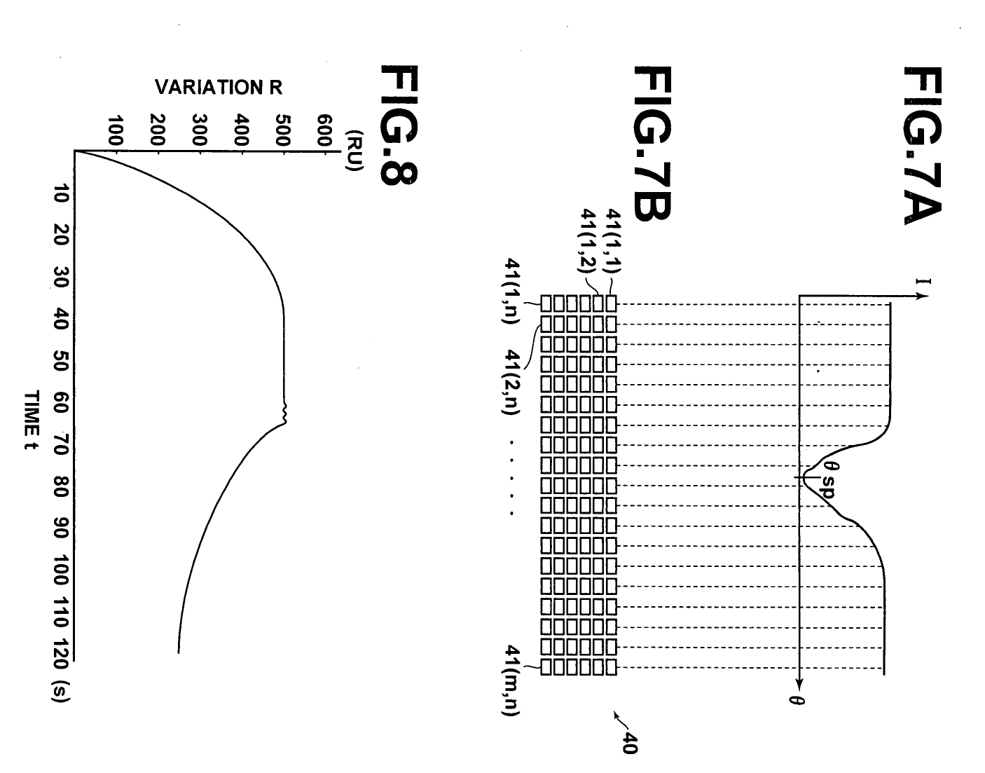

FIGS. 7A and 7B are diagrams for explaining the relationship between light intensity I for each incident angle θ of the light beam, which is totally internally reflected at the interface 12a, and the outputs of the two dimensional CCD imaging element 40. Here, the relationship between the incident angle θ of the light beam 30 with respect to the interface 12a and the light intensity I is as illustrated in the graph of FIG. 7A.

Light that enters the interface 12a at a specific incident angle θₛₚ excites surface plasmons at an interface between the metal film 12 and the sensing substance 14. Therefore, the reflected light intensity I sharply drops for this light. That is, θₛₚ is the attenuated total reflection angle, and the reflected light intensity I assumes its minimal value at the angle θₛₚ. The drop in the reflected light intensity I is observed as a dark line within the reflected light, as indicated by reference letter D in FIG. 3.

FIG. 7B illustrates the lateral directions of the vertical transfer CCD'S 41 of the two dimensional CCD imaging element. As described previously, the positions of the vertical transfer CCD's 41 in the lateral direction are in one-to-one correspondence with the incident angles θ.

The signal processing section 65 calculates the attenuated total reflection angle θₛₚ, based on the values of the reflected light intensities I, which are input from the A/D converter 54. Note that desired signal processes may be administered to profiles, such as that illustrated in FIG. 7A, to detect the attenuated total reflection angle θₛₚ with high accuracy. For example, Fourier transform may be administered to profiles, to separate signals from noise with a spatial frequency. Alternatively, smoothing may be performed in the direction of the incident angles θₛₚ, to reduce noise. By deriving median points or minimal values from profiles, in which the S/N ratios have been improved by the signal processes, the attenuated total reflection angle θₛₚ can be detected with high accuracy.

As described previously, if the test target bonds with the sensing substance 14, which is in contact with the metal film 12 of the measuring unit 10, the refractive index of the sensing substance 14 changes. Accordingly, the attenuated total reflection angle θₛₚ also changes. Here, the attenuated total reflection angle θₛₚ, which was determined by the first measurement after the sample liquid is supplied to the measurement flow path 76 of the measuring unit 10 is designated as θₛₚ(Os). The attenuated total reflection angle θₛₚ, which is determined by a measurement performed t seconds after initiation of measurement operations, is designated as θₛₚ(ts). The variation R of the attenuated total reflection angle θₛₚ is defined as the difference between θₛₚ(ts) and θₛₚ(Os). That is, the variation R at time t is represented by the formula:
R=θₛₚ(ts)−θₛₚ(Os)
At this time, the variation R represents the change of the attenuated total reflection angle θₛₚ over time. That is, the variation R reflects the temporal change of the bonding state between the sensing substance and the test target within the sample liquid. Note that the variation R, which is determined at each measurement, is correlated with the measurement time t thereof, and recorded in the memory section 66 of the signal processing section 65. The variation R is also output to the display section 62, and a graph (sensorgram) that represents the relationship between the elapsed time t and the variation R, such as that illustrated in FIG. 8, is sequentially displayed. Note that in FIG. 8, the units of the horizontal axis (time) is seconds; and that the units of the vertical axis (variation R) are Resonance Units (RU). 1000RU corresponds to an angle of 0.1 degrees.

The signal processing section 65 completes measurements of the bonding state after a predetermined amount of time passes from the initiation of measurement of the measuring unit 10. A bond curve is derived by fitting a speed equation to the sensor grams. A bonding speed constant is obtained from the bond curve. The bond curve and the bonding speed constant are output to the display section 62. The display section 62 displays the bond curve and the bonding speed constant, in addition to the sensorgrams. Note that it is preferable that data regarding the sensing substance and the sample liquid be displayed as necessary.

Next, the operations, by which dissociating states are judged when the sample liquid within the measurement flow path 76 is replaced with buffer liquid, will be described. After measurement of the bonding state, the buffer liquid supply path 79 is connected to the tube 74 by the switchable pump 77, and buffer liquid is supplied to the measurement flow path 76 of the measuring unit 10. Note that supply of the buffer liquid is ceased when the measurement flow path 76 is filled with the buffer liquid. Measurements to follow thereafter are performed in a state in which the measurement flow path 76 is filled with the buffer liquid. Note that air may be supplied prior to supply of the buffer liquid, and the measurement flow path 76 may be filled with the buffer liquid after it is once filled with air. This replacement may be performed by manual operations, or performed automatically, by a control means (not shown), which is connected tot the measuring means 61 and the switchable pump 77.

In the case that the dissociating state is measured as well, the variation R of the attenuated total reflection angle θₛₚ is measured every 0.5 seconds, and sensorgrams are output to the display section 62. After a predetermined amount of time passes, the display section 62 displays a dissociating curve and a dissociating speed constant as well as the sensorgrams. Note that it is preferable that data regarding the sensing substance and the sample liquid be displayed as necessary.

As is clear from the above description, in the two dimensional CCD imaging element 40, the lateral directions of the vertical transfer CCD's 41 are parallel with respect to the plane that includes the light beam incident on the interface 12a and reflected light thereof. The charges of only the vertical transfer CCD's 41 are added and output. By detecting the intensity of the light beam 30, which is totally internally reflected at the interface 12a using the two dimensional CCD imaging element 40, the time required to read signals out therefrom can be reduced. Accordingly, the intervals between measurements of the state of attenuated total reflection can be shortened.

In addition, the two dimensional CCD imaging element 40 is of the charge transfer type. Therefore, noise during readout of signal charges can be reduced, by adding and outputting the charges of the columns of the vertical transfer CCD's. Accordingly, the S/N ratio of the read out signals is improved.

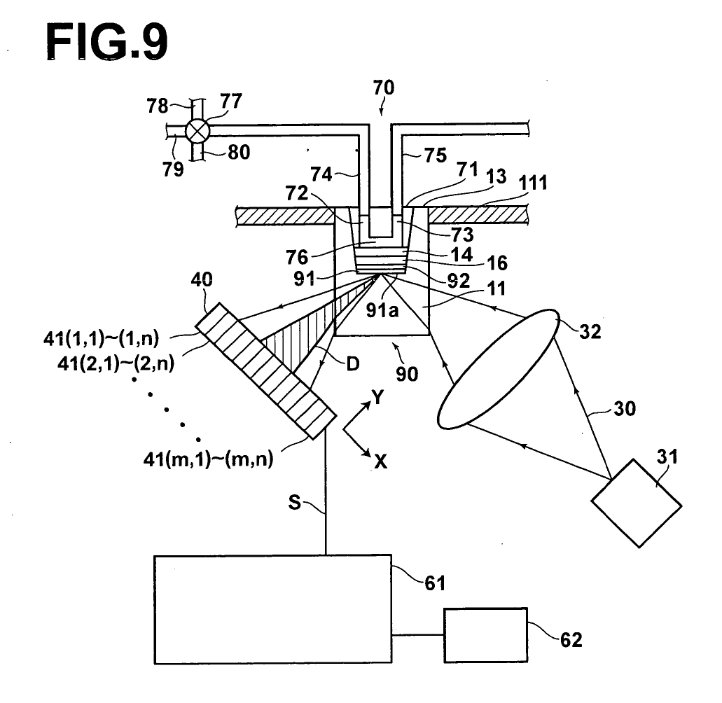

Next, a second embodiment of the present invention will be described with reference to FIG. 1 and FIG. 9.

The construction of the second embodiment is substantially the same as that of the first embodiment. Therefore, only one structural element that differs from that of the first embodiment is denoted with a reference number within parentheses in FIG. 1. In FIG. 9, structural elements which are the same as those illustrated in FIG. 3 are denoted with the same reference numerals, and descriptions thereof will be omitted unless particularly necessary.

The sensor that utilizes attenuated total reflection of the second embodiment is a previously described leaky mode sensor, and is configured to employ measuring units 90. A gladding layer 91 is formed on a surface (the upper surface in FIG. 9) of the dielectric block 11 of the measuring unit 90. An optical waveguide layer 92 is formed on the cladding layer 91.

The dielectric block 11 is molded from synthetic resin or optical glass, such as BK7, for example. The cladding layer 91 is formed as a thin film, from a dielectric having a lower refractive index than that of the dielectric block 11, or from a metal such as gold. The optical waveguide layer 92 is also formed as a thin film, from a dielectric having-a higher refractive index than that of the cladding layer 91, such as PMMA. The film thickness of the cladding layer is approximately 36.5 nm in the case that it is formed as a thin gold film. The film thickness of the optical waveguide layer is approximately 700 nm in the case that it is formed from PMMA.

In the leaky mode sensor having the construction described above, the light beam 30 is emitted from the laser light source 30 so as to pass through the dielectric block 11 and enter the cladding layer 91. If the light beam 30 impinges on the cladding layer 91 at an incident angle greater than or equal to a total internal reflection angle, the light beam 30 is totally internally reflected at an interface 91a between the dielectric block 11 and the cladding layer 91. However, light that passes though the cladding layer 91 and enters the optical waveguide layer 92 at a specific angle and which has specific wave numbers is propagated through the optical waveguide layer 92 in a waveguide mode. When the waveguide mode is excited in this manner, most of the incident light is taken into the optical waveguide layer 92. Therefore, the intensity of the light which is totally internally reflected at the interface 91 drops sharply, that is, attenuated total reflection occurs.

The wave number of the guided light within the optical waveguide layer 92 depends on the refractive index of the sensing substance 14, which is placed on the optical waveguide layer 92. Therefore, a bonding state between the sensing substance 14 and a test target can be measured, by determining the specific incident angle at which attenuated total reflection occurs. In addition, variations R that reflect temporal changes in the states of attenuated total reflection for each measuring unit 90 can also be measured, based on output from the two dimensional CCD imaging element 40.

In the second embodiment, in the two dimensional CCD imaging element 40, the lateral directions of the vertical transfer CCD's 41 are parallel with respect to the plane that includes the light beam incident on the interface 12a and reflected light thereof, as in the first embodiment. The charges of only the vertical transfer CCD's 41 are added and output. By detecting the intensity of the light beam 30, which is totally internally reflected at the interface 12a using the two dimensional CCD imaging element 40, the time required to read signals out therefrom can be reduced. Accordingly, the intervals between measurements of the state of attenuated total reflection can be shortened. In addition, other advantageous effects, which are obtained by the first embodiment, are also obtained by the second embodiment.

What is claimed is:

1. A sensor that utilizes attenuated total internal reflection, comprising:
a light source, for emitting a light beam;
a measuring unit, constituted by: a dielectric block which is transparent with respect to the light beam; a thin film layer, which is formed on a surface of the dielectric block; and a sample holding mechanism, for holding a sample on the thin film layer;
an optical system, for causing the light beam to enter the dielectric block at various angles of incidence, such that total internal reflection conditions can be obtained at an interface between the dielectric block and the thin film layer;
two dimensional imaging means, constituted by a plurality of photoelectric converting elements which are arranged in the vertical and horizontal directions, for detecting the intensity of the light beam, which is totally reflected at the interface; and
measuring means, for measuring the state of attenuated total internal reflection, based on the output from the two dimensional imaging means;
the photoelectric converting elements of the two dimensional imaging means being arranged such that a first direction in which they are arranged, from between the vertical and horizontal directions, is parallel to a plane that includes the light incident on the interface and reflected light; and
the two dimensional imaging means only outputting the sums of charges of the photoelectric converting elements which are arranged in a second direction, from between the vertical and horizontal directions, not parallel to the plane that includes the incident light and the reflected light.

2. A sensor that utilizes attenuated total internal reflection as defined in claim 1, wherein:
the two dimensional imaging means is an imaging means of the charge transfer type.

3. A sensor that utilizes attenuated total internal reflection as defined in claim 2, wherein:
the two dimensional imaging means is a two dimensional CCD imaging element.
